(19) United States
(12) Patent Application Publication
(10) Pub. No.: US 2011/0282946 A1
(43) Pub. Date: Nov. 17, 2011

(54) PERSONAL UNIQUE URL ACCESS PROCESSING SYSTEM

(75) Inventors: Susann Keohane, Austin, TX (US); Gerald F. McBrearty, Austin, TX (US); Shawn P. Mullen, Buda, TX (US); Jessica Murrillo, Austin, TX (US); Johnny M. Shieh, Austin, TX (US)

(73) Assignee: International Business Machines Corporation, Armonk, NY (US)

(21) Appl. No.: 12/779,971

(22) Filed: May 14, 2010

(51) Int. Cl. G06F 15/16

(52) U.S. Cl. 709/206; 709/204

(57) ABSTRACT

A method, programmed medium and system are provided for sending notice to a website representative whenever a specific and unique website is being accessed by an inquiring party seeking information regarding the website content. Contact information is exchanged between an inquiring party and a website representative and whenever the inquiring party views the unique URL which was provided by the website representative, the website representative is contacted with the inquiring party's phone number in real-time with the information that the inquiring party is now viewing the website.

### FIELD OF THE INVENTION

The present invention relates generally to information processing systems and more particularly to a methodology and implementation for enabling selective access to a unique universal resource locator (URL) address.

### BACKGROUND OF THE INVENTION

The availability of the Internet and ease of access through the Internet to business and/or product websites is a very valuable tool in generating new sales of products and providing detailed product and other information to potential buyers. For example, a salesperson may meet a potential buyer at a trade show and give the potential buyer a business card which contains contact information in the event the buyer wishes to contact the salesperson in the future regarding one or more products being offered for sale. On many occasions, there is not sufficient time to fully explain all of the details of a product in which a buyer is interested. In general, a buyer may be given a universal resource locator or URL address of a website which the buyer may access to obtain further product information. Many times, however, the potential buyer may access the given website and still have questions about a product. Unfortunately, in the past, the salesperson is unaware that the buyer has accessed the product website and is unable to answer the buyer's questions in a timely manner. This problem also exists in non-commercial websites where information is available concerning many subjects not necessarily involving the purchase of a product.

Thus, there is a need to provide a network server access processing system which is enabled to avoid the problems set forth above and further to facilitate a timely communication between an inquiring person seeking information from a website and a representative of the website proprietor who is able to provide the additional information being sought.

### SUMMARY OF THE INVENTION

A method, programmed medium and system are provided for sending notice to a website representative whenever a specific and unique website is being accessed by an inquiring party seeking information regarding the website content. Contact information is exchanged between an inquiring party and a website representative and whenever the inquiring party views the unique URL which was provided by the website representative, the website representative is contacted with the inquiring party's phone number in real-time with the information that the inquiring party is now viewing the website. In an exemplary embodiment, a seller or salesperson is provided with the ability to exactly track a business contact or potential buyer's interest and connection with a selling website. The sales person exchanges an electronic business card or email with a potential buyer, after which whenever that buyer views the unique URL on the business card, the sales person is contacted in real-time with the information that this particular buyer is now viewing the salesman's website. When an email or electronic business card is exchanged, the buyers contact information is stored on a private database in association with the singular one time URL given to the buyer. Whenever there is a connection on this unique URL, it is known that this particular buyer is viewing the product. The server will then automatically contact the salesperson and who may then contact the buyer (for example by cell phone) at the very moment that the buyer is viewing the seller's website.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of an exemplary computer system or device using the present invention;

FIG. 3 is a flow chart illustrating an operational sequence which may occur in a seller's personal communication device in connection with an exemplary contact processing transaction;

FIG. 4 is a flow chart illustrating an operational sequence which may occur in a buyer's personal communication device in connection with an exemplary contact processing transaction; and

FIG. 5 is a flow chart illustrating an operational sequence which may occur in a seller's website server in connection with an exemplary contact processing transaction.

### DETAILED DESCRIPTION

The various methods discussed herein may be implemented within a computer system which includes processing means, memory, storage means, input means and display means. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a networked system using personal communication devices and/or other portable or wireless devices, it is understood that disclosed methodology may also be applied in many other available and future devices and systems such as cell phones and other personal wireless and/or hand-held devices, including any input device such as keyboards, keypads, pointing devices, touch-sensitive screens or touch-sensitive input pads, to achieve the beneficial functional features described herein.

The disclosed system provides a sales person with the ability to exactly track a business contact or potential buyer's interest and connection with the selling website. In an example, a sales person exchanges an electronic business card or email with a potential buyer, after which whenever that buyer views the URL on the business card, the sales person is contacted in real-time with the information that this particular buyer is now viewing the salesman's website. Initially, when an email or electronic business card is exchanged with a buyer, the buyer's contact information is stored on a private database in association with the singular one time URL given to the buyer. Whenever there is a connect on this unique URL, it is known that this particular buyer is viewing the product. The server will then automatically contact the salesperson who made the business contact with the buyer. Unique URL addresses may be generated from a listing of a range of URL specific addresses which may be made available for assignment by a seller to individual potential buyers. Thus each of these unique URLs is associated with a specific buyer as may be assigned by a seller. Individual sales personnel are allotted URL specific ranges. For example, a Seller may be allotted “ww.foobar.com/new_widget/[200,300]”. This allows the salesperson to, for example, call that particular buyer at the very moment the buyer is accessing the unique URL associated with that buyer. Thus, for example, a website processing function may automatically send an email or other message to a seller who is associated with a buyer who is accessing the seller website. The notification message may be sent to the seller's personal desktop computer or to the seller's personal mobile communication device so that the seller need not be at the seller's desk to respond to the buyer's website access. The seller may be notified on the seller's mobile phone for example, and given the phone number of the buyer in the notification message so that the seller may then immediately respond by calling the buyer from the seller's cell phone.

The salesperson may then provide any information requested by the buyer while the buyer is viewing the salesperson's website. It is here noted that the present invention is not limited to a seller-buyer transaction but rather may be implemented in connection with any non-commercial or informational website where it is desired to have a website representative contact a person seeking information presented on the website at the same time that the person seeking the additional information is accessing the particular website.

The electronic business card exchange may be implemented via infrared communications. For example, two individuals could align their mobile personal communication devices at the infrared points, and their business contact information would be exchanged. This is more common with Bluetooth enabled cell phones. The initial information exchange may also be accomplished through an email communication.

In a specific example, Seller and Buyer meet and exchange electronic business cards. Seller's business card is dynamically injected with a one time unique URL and provided to Buyer. Seller's cell phone registers this one time URL with the website server. The server stores the one time URL in association with information about Buyer and Seller. At a later date, Buyer decides to look up Seller's company and products via the Internet. When the server receives an access hit on the one time URL, the server connects the Buyer to the generic product/company page at the website. The server also performs a DB lookup on the to unique one time URL to discover the Buyer information as well as the Seller's information. It discovers that Seller is the salesperson and Buyer is the potential customer. The server then sends a message to Seller's cell phone. The message will indicate that Buyer has accessed the unique URL and, inter alia, give the Buyer's phone number. Seller may then call Buyer at the exact moment when Buyer is looking into the product being offered by Seller.

In another embodiment, a timer may be implemented to notify the seller if the buyer has not accessed the unique URL for a predetermined number of days form the initial contact and exchange of contact information.

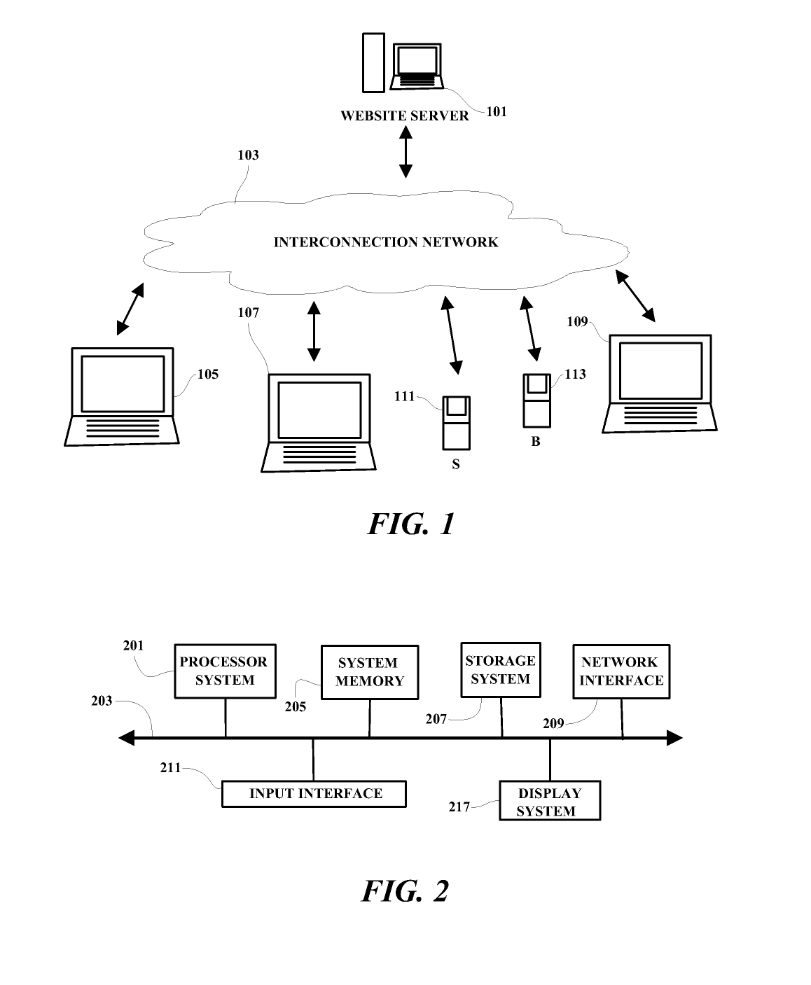

In the drawings, FIG. 1 illustrates an exemplary environment in which the present invention may be implemented. As shown, a website server 101 may be accessed through an interconnection network 103, such as the Internet, by a plurality of client devices including computer terminals 105, 107 and 109 and other wireless or mobile personal communication devices 111 and 113. The client devices 105, 107 and 109 may be laptop computers and the wireless client devices 111 and 113 may be personal wireless communication devices.

FIG. 2 illustrates several of the major components of a computer system which may be used to implement the present invention. The components shown may be implemented in any of the devices of FIG. 1 including the server 101, laptops 105, 107 and 109 and personal devices 111 and 113. As shown, a processor system 201 is connected to a main bus 203. The main bus 203 is also coupled to, inter alia, system memory 205, a local storage system 207, a network interface 209, and an input interface 211. The main bus is also connected to a display system 217. The input and/or display system may also comprise a touch-sensitive screen or optically-sensitive input pad (not shown). Additional devices and bus systems, which are not shown, may also be coupled to the system main bus 203.

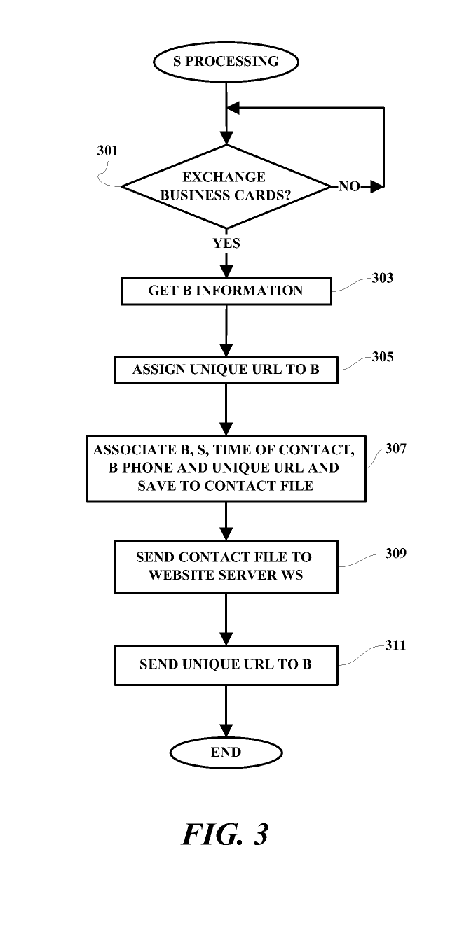

In FIG. 3, there is shown an exemplary flowchart illustrating a processing sequence on a seller's (“S”) communication device. As shown, when it is determined that there is an exchange of business cards 301, the seller's device 111 will get the buyer's (“B”) information 303 (e.g. name, company, phone numbers, email, etc.) as a result of the exchange through, for example, an IR port or Bluetooth or email communication as hereinbefore noted. Next, a unique URL is assigned to B 305 (either by S 111 or by the website server WS 101) and an association 307 or file is created which associates, for example, B, S, the time of initial contact and the unique URL assigned to B. This file or association, which may be in a database format, is saved and either stored 307 at the S device or sent and stored to the website server WS 309 or both. Next, the unique URL assigned to B is sent from S to B 311 for B's subsequent use in accessing S's website.

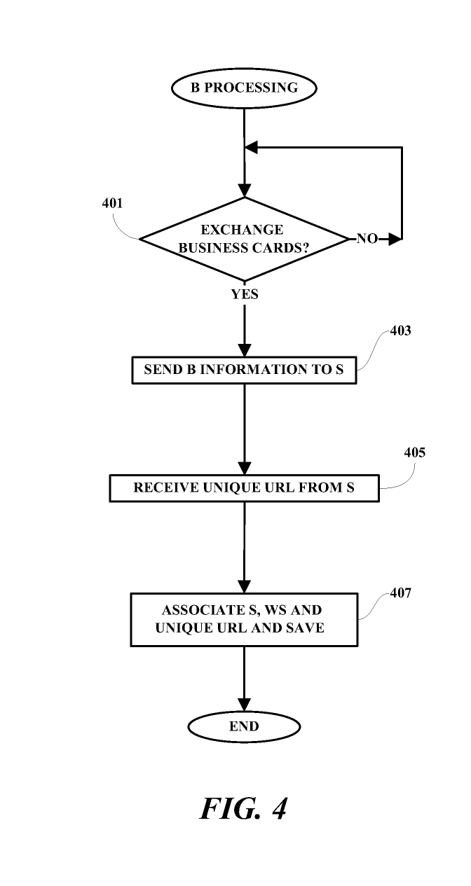

In FIG. 4, there is shown an exemplary flowchart illustrating a processing sequence on a buyer's (“B”) communication device. As shown, when it is determined that there is an exchange of business cards 401, B's information is sent to S's device 403 and after S assigns and sends the unique URL to B, that URL is received by B 405 and a file or association is formed and saved containing S, the website WS, and the unique URL. Later, when B wishes further information, B may use B's device to access the saved unique URL at S's website. When B's assigned unique URL is accessed by B, The website server will automatically send a message to S of the access as hereinbefore explained.

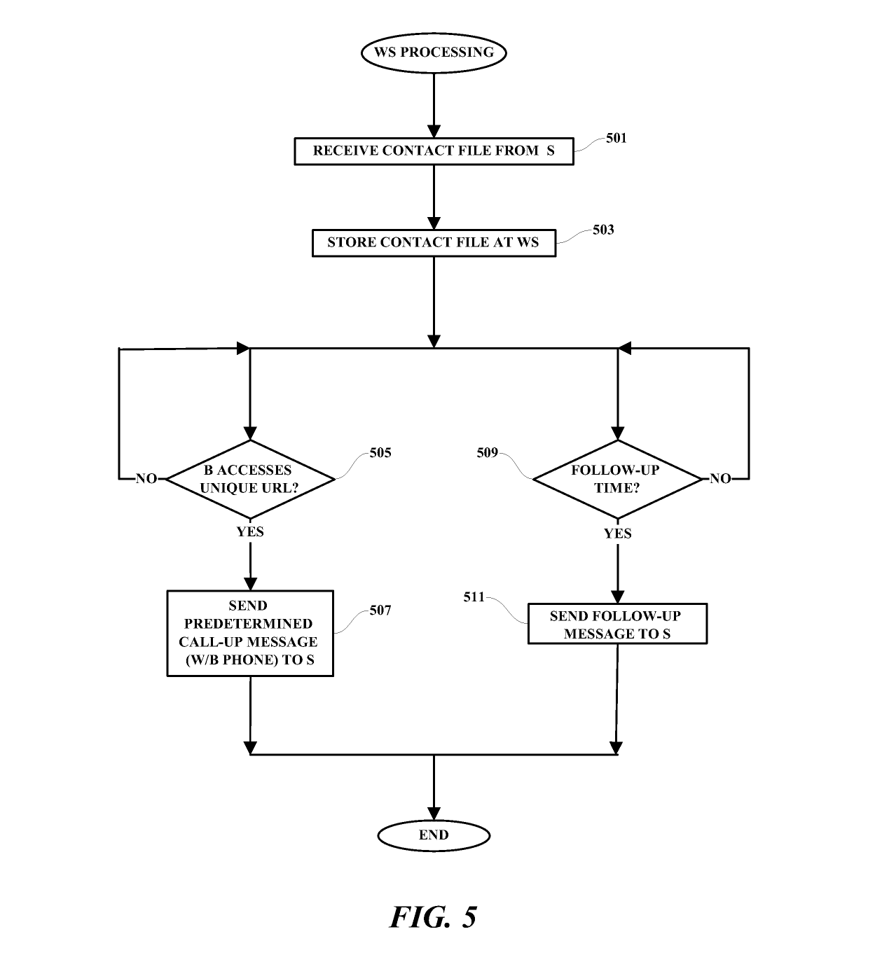

In FIG. 5, there is shown an exemplary flowchart illustrating a processing sequence on the seller's website server WS. As shown, the server WS 101 initially receives the contact data file from S 501 containing, inter alia, the association of S, B, time of initial contact, unique URL assigned to B and the cell and/or other phone number of B. The contact file is then stored at the website server WS 503. Subsequently, when B accesses the unique URL 505, the server sends a predetermined message to S 507 which may include B's cell phone number along with a notation that B is currently accessing B's unique URL. Alternatively, if B has not accessed B's unique URL for a predetermined follow-up time 509 from the time of initial contact, then the server WS may send a message to S which, for example, may include B's cell number and the elapsed time from the initial contact with B and a notation to follow-up the initial contact with B.

Thus, there has been provided a network server access processing system and methodology to facilitate a timely and personal communication between a person seeking information from a website and a personal representative of the website proprietor who is able to provide the additional information being sought at the same time that the person seeking additional information is accessing the proprietor's website.

It is understood that the flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood that the specific example presented herein is not intended to be limiting since the functional combinations disclosed herein may be implemented in many different environments and applications including, for example, applications involving the visualization of business processes and movement of emails, task lists, task list items and other system data components within an overall system data containment environment or application.

The method, system and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including any portable or fixed, volatile or non-volatile memory media device, including CDs, RAM and “Flash” memory, or other semiconductor, optical, magnetic or other memory media capable of storing code, from which it may be loaded and/or transmitted into other media and executed to achieve the beneficial results as described herein. The disclosed methodology may also be implemented using any available input and/or display systems including touch-sensitive screens and optically-sensitive input pads. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing a notification to a first party of a website access by a second party, said method comprising:
providing a first device used by said first party with identity information of said second party;
providing a second device used by said second party with a unique website uniform resource locator (URL) address;
associating said unique URL address with only said second party in a contact file;
saving said contact file;
sending said contact file to a server including said unique URL address, said server being operable to save said contact file, said server being further operable for determining when said second party accesses said unique URL address; and
providing notice to said first device when said second party accesses said unique URL address.

2. The method as set forth in claim 1 wherein said notice is provided automatically by said server by sending an electronic communication to said first device when said second party accesses said unique URL address.

3. The method as set forth in claim 2 wherein said first device is a wireless communication device.

4. The method as set forth in claim 3 wherein said identity information is provided from said second device to said first device through a Bluetooth communication link.

5. The method as set forth in claim 3 wherein said identity information is provided from said second device to said first device through an infrared (IR) link.

6. The method as set forth in claim 2 wherein said identity information includes a phone number for said second party, and said electronic communication is an email notification sent to said first party and including said phone number of said second party.

7. The method as set forth in claim 6 wherein said first device and said second device are wireless communication devices.

8. A computer readable storage medium having computer readable program code embodied therewith, the computer readable program code being effective when read by a server for enabling said server to process a notice to a first party of a website access by a second party to a unique uniform resource locator (URL) address by:
saving a contact file received from a first device used by said first party, said contact file containing an association of said first party, said second party and said unique URL address, said contact file further including contact information of said first and second parties by which said first and second devices may be contacted;
determining when said second party accesses said unique URL address; and
providing notice to said first device when said second party accesses said unique URL address.

9. The computer readable storage medium as set forth in claim 8 wherein said unique URL address is assigned by said server.

10. The computer readable storage medium as set forth in claim 9 wherein said notice is provided automatically by said server by sending an electronic communication to said first device when said second party accesses said unique URL address.

11. The computer readable storage medium as set forth in claim 10 wherein said first device is a wireless communication device.

12. The computer readable storage medium as set forth in claim 11 wherein said contact information includes a phone number for said second party, and said electronic communication is an email notification sent to said first party and including said phone number of said second party.

13. A computer system for processing a notification to a first party of a website access by a second party, said computer system comprising:
a first device used by said first party, said first device being operable for receiving identity information of said second party;
a second device used by said second party, said second device being operable for receiving a unique website uniform resource locator (URL) address from said first device, said first device being operable for associating said unique URL address with only said second party in a contact file, said first device being operable for saving said contact file;
a server accessible by said first device, said first device including means for sending said contact file to said server, said contact file including said unique URL address, said server including means operable to save said contact file, said server being further including means operable for determining when said second party accesses said unique URL address, said server further including means for providing notice to said first device when said second party accesses said unique URL address.

14. The computer system as set forth in claim 13 and further including means for providing said notice automatically by said server by sending an electronic communication to said first device when said second party accesses said unique URL address.

15. The computer system as set forth in claim 14 wherein said first device is a wireless communication device.

16. The computer system as set forth in claim 13 wherein said identity information is provided from said second device to said first device through a Bluetooth communication link.

17. The computer system as set forth in claim 13 wherein said identity information is provided from said second device to said first device through an infrared (IR) link.

18. The computer system as set forth in claim 14 wherein said identity information includes a phone number for said second party, and said electronic communication is an email notification sent to said first party and including said phone number of said second party.

19. The computer system as set forth in claim 18 wherein said first device and said second device are wireless communication devices.

20. The computer system as set forth in claim 19 wherein said first device and said second device are cell phones.
